(19) United States
(12) Patent Application Publication
(10) Pub. No.: US 2018/0009612 A1
(43) Pub. Date: Jan. 11, 2018

(54) Unloader apparatus for the Beds of Various Trucks and Associated Methods

(71) Applicants: Benjamin Keith Croke, Winston-Salem, NC (US); James Keith Croke, Ellerbe, NC (US)

(72) Inventors: Benjamin Keith Croke, Winston-Salem, NC (US); James Keith Croke, Ellerbe, NC (US)

(21) Appl. No.: 15/203,441

(22) Filed: Jul. 6, 2016

(51) Int. Cl. B65G 67/26; B62D 33/03; B60P 1/00

(52) U.S. Cl. CPC B65G 67/26; B60P 1/006; B62D 33/03

(57) ABSTRACT

The present invention relates to an apparatus and methods of removing material from the bed of a truck, for example, the bed of a pick-up track, The apparatus is an unloader apparatus the has both a bed part and an external part, the bed part designed to be used in the bed of the pick-up truck and the external part designed to be used to move the bed part. The bed part is substantially flat and the external part usually consists of lines that can be moved by means of a force provided by a winch, a moving truck or by some other means.

### FIELD OF THE INVENTION

The present invention relates to an apparatus and methods of removing material from the bed of a truck, for example, the bed of a pick-up truck.

### BACKGROUND OF THE INVENTION

People that use pickup trucks often have a difficult time removing material from the bed of their pick-up trucks. The effort that is involved in removing the material often requires back breaking work. For example, when landscaping material is present, the landscaper often has to reach substantially into the bed of the pickup truck to move the material. Sometimes a shovel or other means of moving the material has to be used.

### BRIEF SUMMARY OF THE INVENTION

The present invention relates to an apparatus and methods of removing material from the bed of a truck, for example, the bed of a pick-up truck. The apparatus is an unloader apparatus that has both a bed part and an external part, the bed part designed to be used in the bed of the pickup truck and the external part designed to be used to move the bed part. The bed part is substantially flat and is designed to fit snugly in the bed of the pickup truck with cutouts that can accommodate the presence of the wheel wells in the bed of the pickup truck. The external part usually consists of lines that can be moved by means of a force provided by a winch, a moving truck or by some other means.

### BRIEF DESCRIPTION OF THE SEVERAL VIEWS OF THE DRAWINGS

FIG. 1 shows a back end view of the bed part of the unloader apparatus of the present invention.

FIG. 2 shows a side view of the bed part of the unloader apparatus of the present invention.

FIG. 3 shows a side view of the unloader apparatus of one embodiment of the invention with both the bed part and the external part evident.

FIG. 4 shows a top down view of a pickup truck containing the unloader apparatus of the invention with both the bed part and external part evident.

FIG. 5 shows a side view of a pickup truck with the unloader apparatus of the present invention in the bed.

FIG. 6 shows a perspective view of the bed of a pickup truck with the unloader apparatus present.

FIG. 7 shows a side view of the bed part and a bristle component that can be snapped on to the bed part.

### DETAILED DESCRIPTION OF THE INVENTION

The present invention relates to an unloader apparatus that is ideally suited to remove material from the bed of a truck. In an embodiment, the apparatus is ideally suited to remove material from the bed of a pick-up truck. In an embodiment, the material in the bed of the pick up truck may not be entirely removed but may simply be moved from the front of the bed to the back of the bed so that an individual can pick up the material in the back of the bed of the pick up truck.

In an embodiment, the unloader apparatus comprises a bed part and an external, part to the apparatus. The bed part is a substantially flat device that physically moves the material by applying a force on the material. The external part is a part that is attached to the bed part and acts to allow an individual to apply a force to the bed part, thereby causing the bed part to move. The movement of the bed part causing the material in the bed of the pickup truck to move.

In an embodiment, the material that is to be removed includes but is not limited to sand, gravel, soil, sod, clay, cement, brush, leaves, landscaping material, construction material, boxes, or any other material that may be placed in the back of a pickup truck.

The present invention will now be described with reference to the figures. This description is not to be limiting but rather is merely illustrative of apparatuses and methods of the invention may operate.

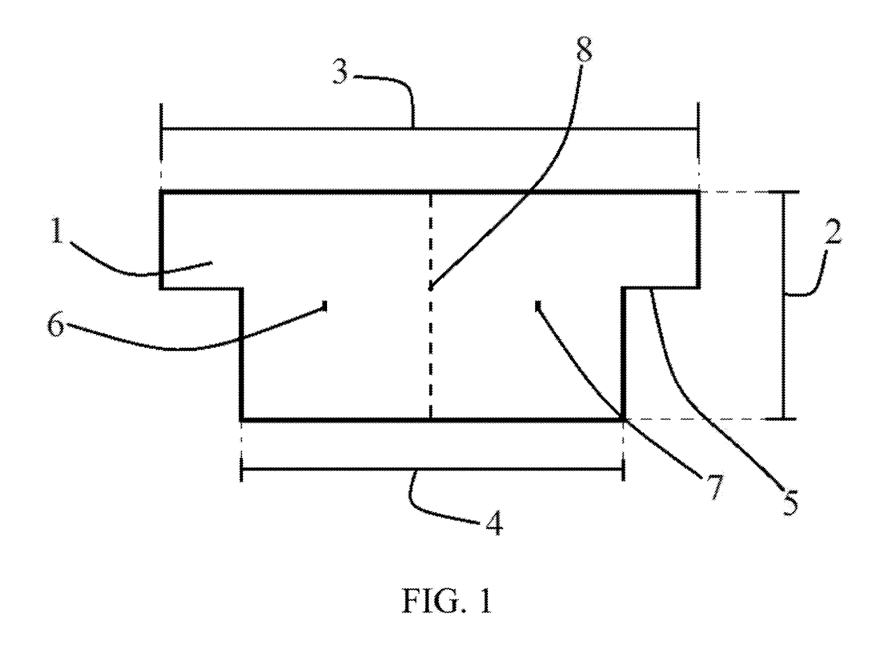

FIG. 1 shows a back end view of the bed part 1 of the unloader apparatus of the present invention. The bed part 1 has a substantially T-like (tee-like) shape that has both a height 2 and two widths 3 and 4. The upper width 3 is designed to be substantially equal to the girth (the width) of the bed of the upper part of the pickup truck. The lower width 4 is designed to be substantially equal to the distance (the width) between the wheel wells in the bed of the pickup truck. As can be seen in FIG. 1, there appear cut-outs 5 for accommodating the wheel wells the pickup truck when the bed part 1 is moved from a position that is adjacent the front end of the, bed of the pickup truck to the back end of the bed of the pickup truck. The cutouts 5 are designed to be substantially the same size as the height and the width of the wheel wells. The external part (not shown) is designed to connect at left point 6 and right point 7. In an embodiment, left point 6 and right point 7 are equidistance from center line 8, an imaginary line that intersects bed part 1 in a vertical direction that is substantially in the center the center line 8 divides upper width 3 in half). In an embodiment, left point 6 and right point 7 also are situated at substantially heights on bed part. In an embodiment, it has been found that point 6 (also called second point) and right point 7 (also called first point) should be situated at a level that is slightly less than the height of cutouts 5 to prevent torqueing of the bed part 1. If the left point 6 and right point 7 are too high, the, bed part 1 torques in a direction where the top part of the bed part falls towards the back of the pickup truck. If the left point 6 and right point 7 are too low, the bed part 1 torques in a direction where the top part of the bed part falls towards the front of the pickup truck.

The bed part may be made of any of a plurality of materials. Included materials include but are not limited to plywood such as pressure treated plywood, strengthened metals, aluminum, pultruded fiberglass, various strong thermoplastics, other hardened plastics, or combinations thereof.

In an embodiment, the bed part has a height that is on the order of the depth of the bed of the pickup truck or less than the depth of the bed of the pickup truck. In an embodiment, the thickness of the bed part is on the order of between about 3/16 to 1½ inches. In embodiments, the thickness of the bed part is the same as commercially available plywood. For example, the thickness of the bed part may be any of the following thicknesses: ¼, 7/32, 11/32, ⅜, 15/32, ½, 19/32, 23/32, ¾, or 1 inch. The thickness can be selected based upon the intended use of the bed part with the understanding that the bed part should be sufficiently sturdy so as to not encounter problems with moving and/or removing material from the bed of a pickup truck. It should also be understood that if plywood is to be used, a laminate may be placed over the plywood (for example a polyurethane based laminate) that further protects the plywood from the elements. Paint (e.g., an oil based outdoor paint) may also be used that protects the bed part from the elements.

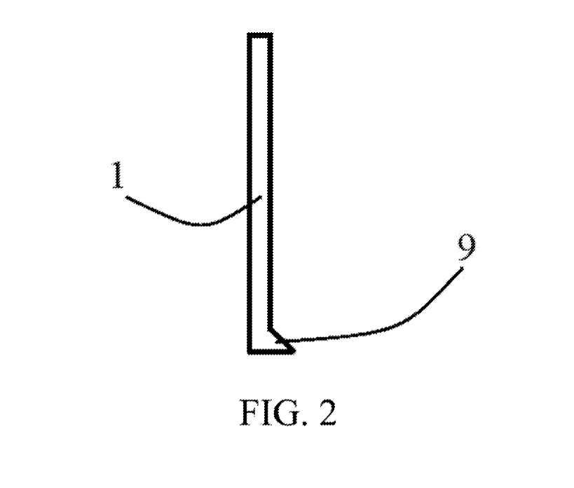

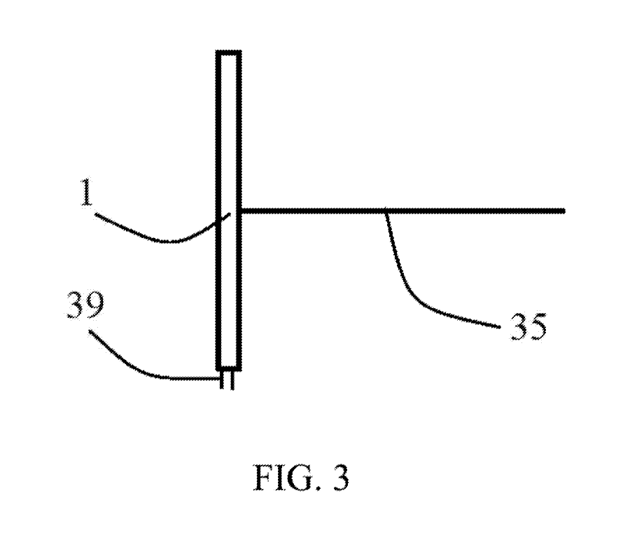

FIG. 2 shows a side view of the bed part 1 of the unloader apparatus of the present invention. This figure is not necessarily drawn to scale but does illustrate that the bed part 1 is substantially flat when viewed from the side. In an embodiment, and as shown in FIG. 2, the bed part may have an angled toe 9 that functions to facilitate removal of material from the back of the pickup truck. The angled toe 9 might also provide some additional stability to the bed part 1 that prevents the bed part 1 from easily torqueing when a force is applied on the bed part by the external part (not shown in FIG. 1 or 2) as shown in FIG. 3.

FIG. 3 shows a side view of the unloader apparatus of one embodiment of the invention with both the bed part 1 and the external part 35 evident. In FIG. 3, it should be apparent that an angled toe is not present as is shown in FIG. 2. Moreover, in an embodiment, the unloader apparatus may also optionally have bristles 39 at the bottom of the bed part 1 that facilitates removal of the material from the bed of the pickup truck. The bristles 39 may not only be present on the very bottom of the bed part 1, but may also be present on the sides of bed part 1 as well as at the sides and top of the wheel well cutouts (see wheel well cutout 5 in FIG. 1). The bristles may be natural bristles or synthetic bristles. Exemplary materials that can be used for the bristles of the present invention include but are not limited to straw, Yucca, Rattan, Broomcorn (sorghum), Bamboo, various animal hairs, Bass, Piassava, Bassine, Palmetto, Palmyra, Rice Root, Tampico, Polyethylene, Poly Corn, PVC (polyvinyl chloride), Carbon fiber, nylon abrasive, polyester, PEEK (Polyetheretherketone), Polystyrene, PTFE (Polytetrafluoroethylene), Tynex A, carbon steel, nickel silver, phosphor bronze, or stainless steel or mixtures thereof. It is useful to have the bristles 39 match the use for which the unloader apparatus is to be used. For example, if a sturdier brush is needed for moving heavier material, the metallic bristles may be used. The density of the bristles may also be varied depending on the intended use wherein the bristle density is enhanced when moving heavier material (and perhaps, smaller material) and a bristle density is reduced when lighter material (and perhaps, larger material) is to be used. For example, if sand is the material to be moved, it is desired that the bristle density be enhanced so that the bristles are able to move the vast majority of sand grains.

The lengths of the bristles 39 may also be varied depending on how they will be used. For example, if a grooved bed liner is used in the bed of the truck, it may be useful to have longer bristles to accommodate the various grooves that appear in the bed liner.

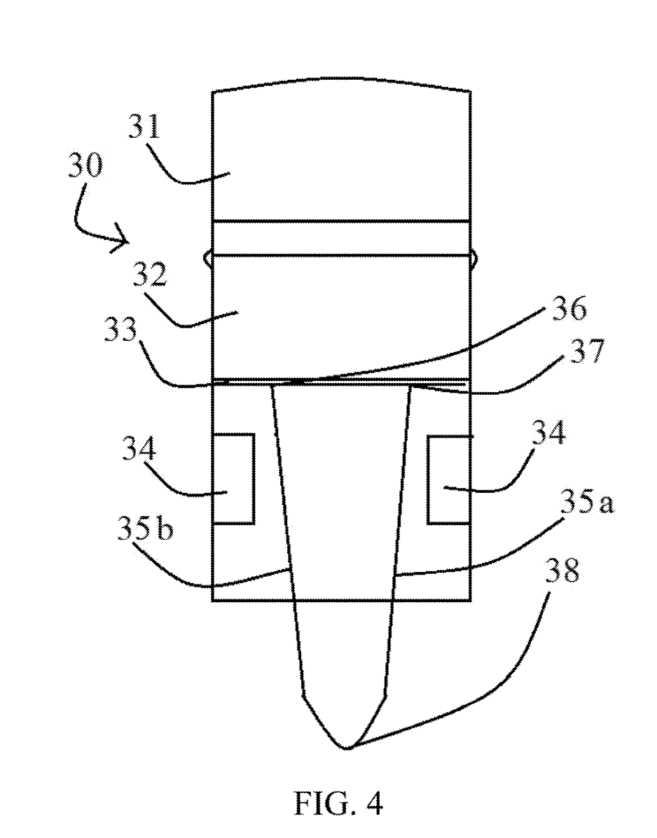

FIG. 4 shows a top down view of a pickup truck 30 containing the unloader apparatus 33, 35, 38 of the invention with both the bed part 33 and external part 35 38 evident. In FIG. 4, the figure shows the hood 31 of the pickup truck 30, the cab 32, and the wheel wells 34. The external part is connected to bed part 33 and is comprised of left line 35b and right line 35a and connection junction 38 wherein right line 35a connects at a first point 37 and left line 35b connects at a second point 36. The connection junction 38 may be a point where the right line 35a and left line 35b are connected together. Alternatively, it is contemplated and therefore within the scope of the invention that the right line 35a and left line 35b are not connected together. In an embodiment, the lengths of right line 35a and left line 35b are substantially equal in length. The lengths of right line 35a and left line 35b should both be longer than the length of the bed of the pickup truck 30 with the gate down. That way, the external part can be connected to a tree, a pole or a winch that allows material that rests in the bed of the pickup truck to be moved when either the truck moves, or the winch or other method of moving the bed part (using the external part) is accomplished.

The lines that comprise right line 35a and left line 35b can be any type of line that, for example, would typically be used for lines in shipping. For example, the lines may include natural or synthetic materials. For example, the lines may include but not be limited to polypropylene, nylon, polyester, aramids, UHMWPE (ultra-high molecular weight polyethylene), Kevlar®, manila, sisal, hemp, cotton, chains, twisted wire, tow straps (usually nylon and/or polyester), or mixtures thereof. If rope is used, the rope may be twisted rope or braided rope. The ropes may further contain a urethane polymer coating, making them resistant to ultraviolet light.

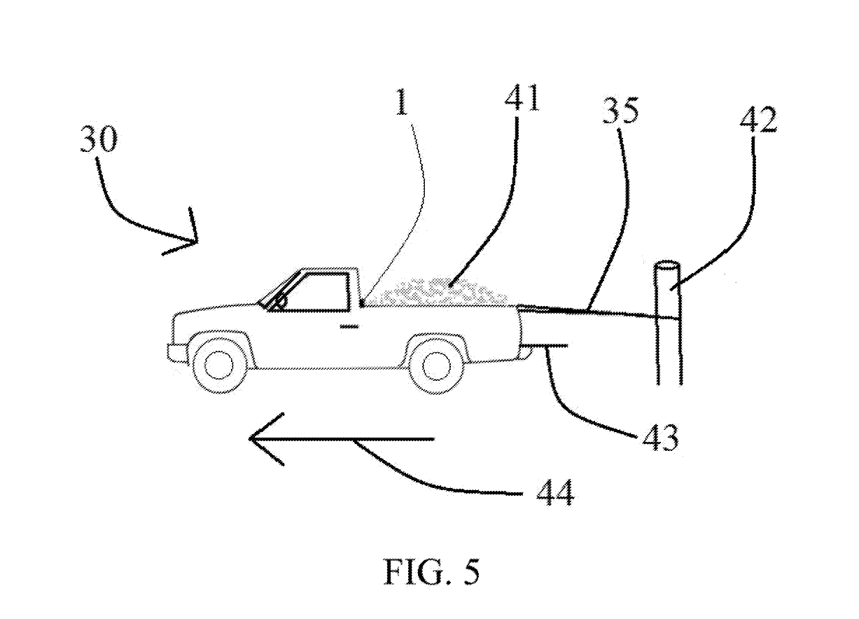

FIG. 5 shows a side view of a pickup truck 30 with the unloader apparatus of the present invention in the bed of the pickup truck. The bed part 1 is present at a location that is forward of material 41. When one wants to remove the material, gate 43 can be put into the open position. External part 35 is comprised of the lines mentioned above. The connection junction 38 (see FIG. 4) can be placed around a tree or a stationary object 42. When pickup truck drives in the direction of arrow 44, the material will be moved off the bed of the truck. Alternatively, the connection junction 38 can be placed in a winch that moves the bed part 1 without having to drive the truck. The material will be moved by the winch pulling on lines 35, which in turn pull on bed part allowing the movement or the removal of the material from the bed of the pickup truck.

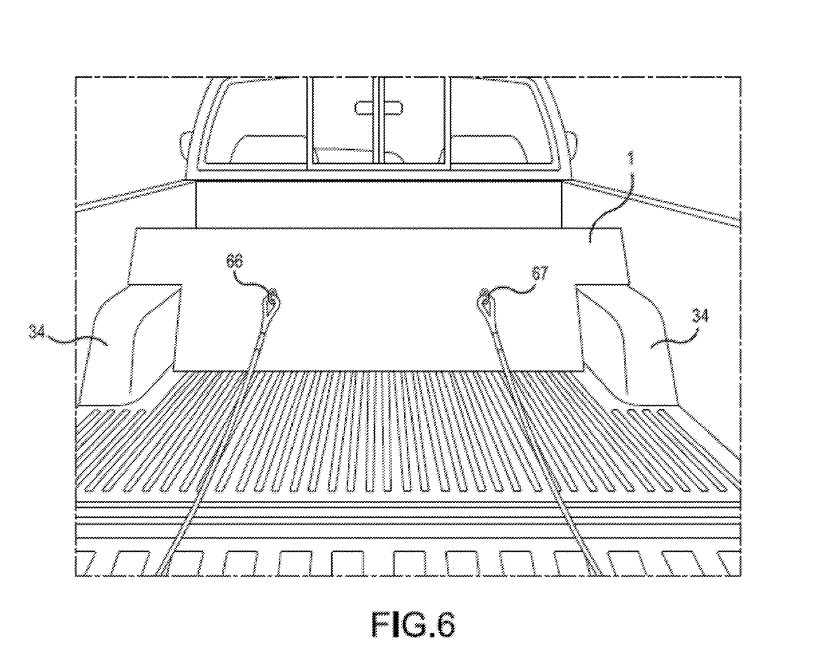

FIG. 6 shows a perspective view of the unloader apparatus of the present invention. Bed part 1 is shown and left point 6 (also called second point as shown in FIG. 1) and right point 7 (also called first point as shown in FIG. 1) show an embodiment of how the lines 35 of external part can be connected to the bed part 1. In the embodiment shown in FIG. 6, the lines 35 (see FIGS. 4 and 5) of external part is connected to bed part 1 by eye bolts 66 and 67. In embodiments, the lines 3 of external part may be connected to bed part 1 by eye bolts, eye lags, U bolts, or J bolts. Other means of connecting the lines 35 to the left and right points 6 and 7. For example, the connection points on the bed part may be holes instead of having hardware connected to it. If holes are present and the lines are ropes, the ends of the ropes can be inserted into the holes and the ends of the ropes made into knots. Alternatively, the ropes can be connected to each other in the back (or the rope can be one continuous rope that goes through one hole, around the back and through the other hole). Alternatively, the end of the rope(s) can be connected to a hard object that is of a size that is not able to traverse through the hole. By connecting the rope to the hard object after the end is through the hole will preclude the rope from being able to be removed from the bed part (without removing the hard of from the end of the rope(s)).

Although FIG. 6 is shown with the device below the depth of the bed of the truck, it should be understood that the device can be taller so that the device height rises to a point above the bed of the truck. In an embodiment, the right point 7 and left point 6 might be adjusted so that when lines 35 are pulled the device is balanced between the upper portion of the apparatus bed part and the lower portion of the apparatus bed part so that the torque is diminished (that is, it does not torque). Consequently, by correctly positioning the right point 7 and left point 6, the act of pulling on the lines will allow the easy moving or removal of material in the bed of the truck without the bed part being torqued.

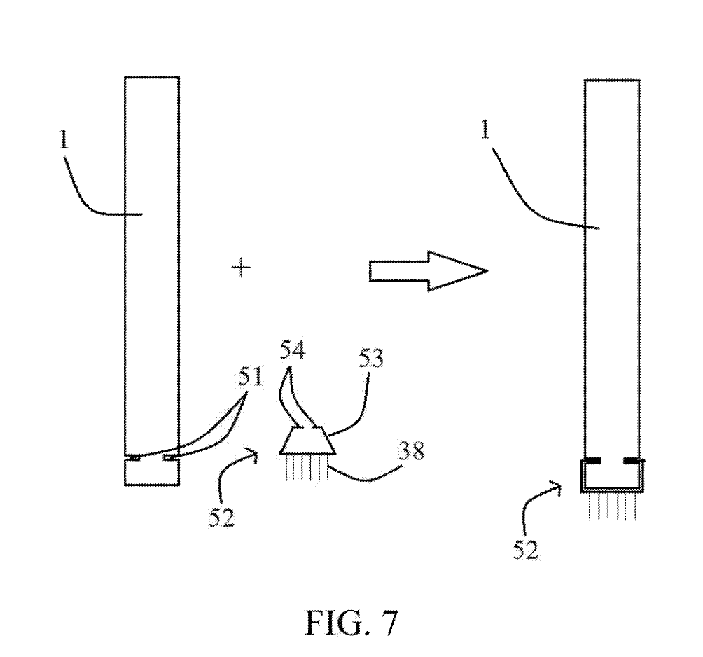

FIG. 7 shows a side view of the bed part 1 and a bristle component 52 that can be snapped on to the be part 1. In an embodiment and as shown in FIG. 7, the bed part 1 has grooves 51 near the bottom the bed part 1 that are designed to accommodate the bristle component 52. The bristle component 52 has flexible side panels 53 and tongues 54 that are designed to fit in the grooves 51. The flexible side panels 53 can be stretched so that they are able to snap into place wherein the tongues 54 fit into the grooves 51 (see the right hand side of FIG. 7).

The present invention also relates to methods of removing material from the bed of a truck (for example, a pickup truck) by using the unloader apparatus of the present invention. The method may also be a method of allowing one to move material from the forward (or front) part of the bed of a pickup truck to the backward (or back) part of the pickup truck.

The present invention further relates to a kit that comprises the unloader apparatus of the present invention. The kit may further comprise a plurality of different external parts (for example, different lines). The kit may further comprise a winch that can be used to pull the external part. In an embodiment, the kit may further comprise bristles that can be snapped on to the bottom of the bed part.

In an embodiment, the present invention relates to an unloader apparatus for placement and use in a bed of a pickup truck, said unloader apparatus comprising a bed part and an external part, the bed part comprising a substantially flat device having a height, and a width that varies depending on location, a top and a bottom, and a right side and a left side, wherein the height is above, substantially equal to or less than a depth of the bed of the pickup truck, and wherein the width is substantially equal to a girth of the pickup truck, the width varying so as to accommodate wheel wells in the bed of the pickup truck, the external part comprises a first line having a proximal end and a distal end and a second line having a near end and a far end, the first line and the second line being substantially equal in length, the proximal end of the first line attached to a first point on the right side of the bed part and the near end of the second line attached to a second point on the left side of the bed part, the distal end of the first line and the far end of the second line being connected together at a connection junction. In an embodiment, the height is substantially equal to or less than a depth of the bed of the pickup truck.

In a variation, the width comprises two widths, a first width that is substantially equal to the girth of the bed of the pickup truck and a second width that is substantially equal to a distance between the wheel wells thereby creating wheel well cutouts.

In a variation, the first point and the second point are spaced equidistance from a center line on the bed part. In a variation, the first point and the second point are situated at substantially the same height on the bed part. In a variation, the first point and the second point are situated below the top of the wheel well cutouts.

In an embodiment, the bed part further comprises bristles that are situated at the bottom of the bed part. In a variation, the bristles comprise one or more of straw, Yucca, Rattan, Broomcorn, Bamboo, various animal hairs, Bass, Piassava, Bassine, Palmetto, Palmyra, Rice Root, Tampico, Polyethylene, Poly Corn, PVC, Carbon fiber, nylon abrasive, polyester, PEEK, Polystyrene, PTFE, Tynex A, carbon steel, nickel silver, phosphor bronze, or stainless steel.

In an embodiment, the bed part comprises pressure treated plywood, aluminum, pultruded fiberglass, a thermoplastic, or combinations thereof.

In an embodiment, the proximal end of the first line and the near end of the second line are attached respectively at the tint point and at the second point by eye bolts, eye lags, U bolts, or J bolts.

In a variation, the bed part further comprises an angled toe.

In an embodiment, the bristles all have a length which is substantially the same. Alternatively, the bristles all have a length which is not substantially the same. The bristles may be of different lengths to accommodate a grooved bed liner in the bed of the pickup truck.

In an embodiment, the unloader apparatus can be folded up for easier storage. In a variation, the apparatus may comprise hinges that allows the apparatus to be folded up for storage. In a variation, the apparatus may be folded in half. In a variation, the apparatus may be folded into thirds or smaller sizes.

In a variation, the bristles are added to the bed part by means of a bristle component.

In an embodiment, the present invention relates to a method of moving material on the bed of a pickup truck wherein the method comprising using the unloader apparatus described above to move the material. In a variation, the method involves removing the material from the bed of the truck.

In an embodiment, the material is one or more of landscaping material or construction material. In a variation, the material is one or more of sand, gravel, soil, sod, clay, cement, brush, or leaves.

In a variation, the material is moved by attaching the first line and the second line to a stationary object and moving the pickup truck. Alternatively, and/or additionally, the material is moved by a winch. In a variation, the material is moved by driving the pickup truck.

It should be understood that the present invention is not to be limited by the above description. Modifications can be made to the above without departing from the spirit and scope of the invention. It is contemplated and therefore within the scope of the present invention that any feature that is described above can be combined with any other feature that is described above (even if those features are not described together). Moreover, it should be understood that the present invention contemplates and it is therefore within the scope of the invention that any element that is described can be omitted from the apparatus and/or methods of the present invention. When a range is given, it is contemplated and therefore within the scope of the invention that subranges within the range are contemplated. Any real number that makes the subrange can be used as an end point to make a sub range. In any event, the scope of protection to be afforded is to be determined by the claims which follow and the breadth of interpretation which the law allows.

1. An unloader apparatus for placement and use in a bed of a pickup truck, said unloader apparatus comprising a bed part and an external part,
the bed part comprising a substantially flat device having a height, and a width that varies depending on location, a top and a bottom, and a right side and a left side, wherein the height is above, substantially equal to or less than a depth of the bed of the pickup truck, and wherein the width is substantially equal to a girth of the pickup truck, the width varying so as to accommodate wheel wells in the bed of the pickup truck,
the external part comprises a first line having a proximal end and a distal end and a second line having a near end and a far end, the first line and the second line being substantially equal in length, the proximal end of the first line attached to a first point on the right side of the bed part and the near end of the second line attached to a second point on the left side of the bed part, the distal end of the first line and the far end of the second line being connected together at a connection junction.

2. The unloader apparatus of claim 1, wherein the width comprises two widths, a first width that is substantially equal to the girth of the bed of the pickup truck and a second width that is substantially equal to a distance between the wheel wells thereby creating wheel cell cutouts.

3. The unloader apparatus of claim 2 wherein the first point and the second point are spaced equidistance from a center line on the bed part.

4. The unloader apparatus of claim 3 wherein the first point and the second point are situated at substantially the same height on the bed part.

5. The unloader apparatus of claim 4, wherein the first point and the second point are situated below the top of the wheel well cutouts.

6. The unloader apparatus of claim 5, wherein the bed part further comprises bristles that are situated at the bottom of the bed part.

7. The unloader apparatus of claim 6, wherein the bristles comprise one or more of straw, Yucca, Rattan, Broomcorn, Bamboo, various animal hairs, Bass, Piassava, Bassine, Palmetto, Palmyra, Rice Root, Tampico, Polyethylene, Poly Corn, PVC, Carbon fiber, nylon abrasive, polyester, PEEK, Polystyrene, PTFE, Tynex A, carbon steel, nickel silver, phosphor bronze, or stainless steel.

8. The unloader apparatus of claim 1, wherein the bed part comprises pressure treated plywood, aluminum, pultruded fiberglass, a thermoplastic, or combinations thereof.

9. The unloader apparatus of claim 1, wherein the proximal end of the first line and the near end of the second line are attached respectively at the first point and at the second point by eye bolts, eye lags, U bolts, or J bolts.

10. The unloader apparatus of claim 1, wherein the bed part further comprising an angled toe.

11. The unloader apparatus of claim 7, wherein the bristles all have a length which is substantially the same.

12. The unloader apparatus of claim 7, wherein the bristles all have a length which is not substantially the same.

13. The unloader apparatus of claim 7, wherein the bristles are added to the bed part by means of a bristle component.

14. A method of moving material on the bed of a pickup truck said method comprising using the unloader apparatus of claim 1 to move the material.

15. The method of claim 14, wherein the material is removed from the bed of the truck.

16. The method of claim 14, wherein the material is one or more of landscaping material or construction material.

17. The method of claim 16, wherein the material is one or more of sand, gravel, soil, sod, clay, cement, brush, or leaves.

18. The method of claim 14, wherein the material is moved by attaching the first line and the second line to a stationary object and moving the pickup truck.

19. The method of claim 14, wherein the material is moved by a winch.

20. The method of claim 18, wherein the material is moved by driving the pickup truck.
